(19) United States
(12) Patent Application Publication
(10) Pub. No.: US 2007/0209243 A1
(43) Pub. Date: Sep. 13, 2007

(54) Apparatus and method for greeting card having motion mechanism

(76) Inventor: Jean-Jacques Toulotte, Woburn, MA (US)

Correspondence Address: BROMBERG & SUNSTEIN LLP, 125 SUMMER STREET, BOSTON, MA, 02110-1618, US

(21) Appl. No.: 11/606,245

(22) Filed: Nov. 29, 2006

Related U.S. Application Data
(60) Provisional application No. 60/740,562, filed on Nov. 29, 2005.

(51) Int. Cl. G09F 1/00

(52) U.S. Cl. 40/124.08

(57) ABSTRACT

A method and apparatus for a greeting card having a motion mechanism. In on aspect, the present invention provides a greeting card that includes an independent spring mounted die cut segment of the main image that is attached to the front panel so that when the consumer holds the card, part of the image has actual motion.

This application claims priority to Ser. No. 60/740,562 filed on Nov. 29, 2005, that status of which is currently pending.

### FIELD OF THE INVENTION

The present application is directed to the field of greeting cards and more particularly to an apparatus and method for a greeting card having a motion mechanism.

### SUMMARY OF THE INVENTION

A method and apparatus for a greeting card having a motion mechanism. In on aspect, the present invention provides a greeting card that includes an independent spring mounted die cut segment of the main image that is attached to the front panel so that when the consumer holds the card, part of the image has actual motion.

### BRIEF DESCRIPTION OF THE DRAWING

The invention is described with reference to the several figures of the drawing, in which:

FIGS. 1A and 1B illustrate embodiments of greeting cards with motion mechanisms attached thereto.

### DETAILED DESCRIPTION OF VARIOUS EMBODIMENTS OF THE INVENTION

It is to be understood that both the foregoing general description and the following detailed description are exemplary and explanatory only and are not restrictive of the invention that is claimed. It may be noted that, as used in the specification and the appended claims, the singular forms “a”, “an” and “the” include plural referents unless the context clearly dictates otherwise. References cited herein are hereby incorporated by reference in their entirety, except to the extent that they conflict with teachings explicitly set forth in this specification.

Referring now to the figures of the drawing, the figures constitute a part of this specification and illustrate exemplary embodiments of the invention. It is to be understood that in some instances various aspects of the invention may be shown schematically or may be exaggerated to facilitate an understanding of the invention.

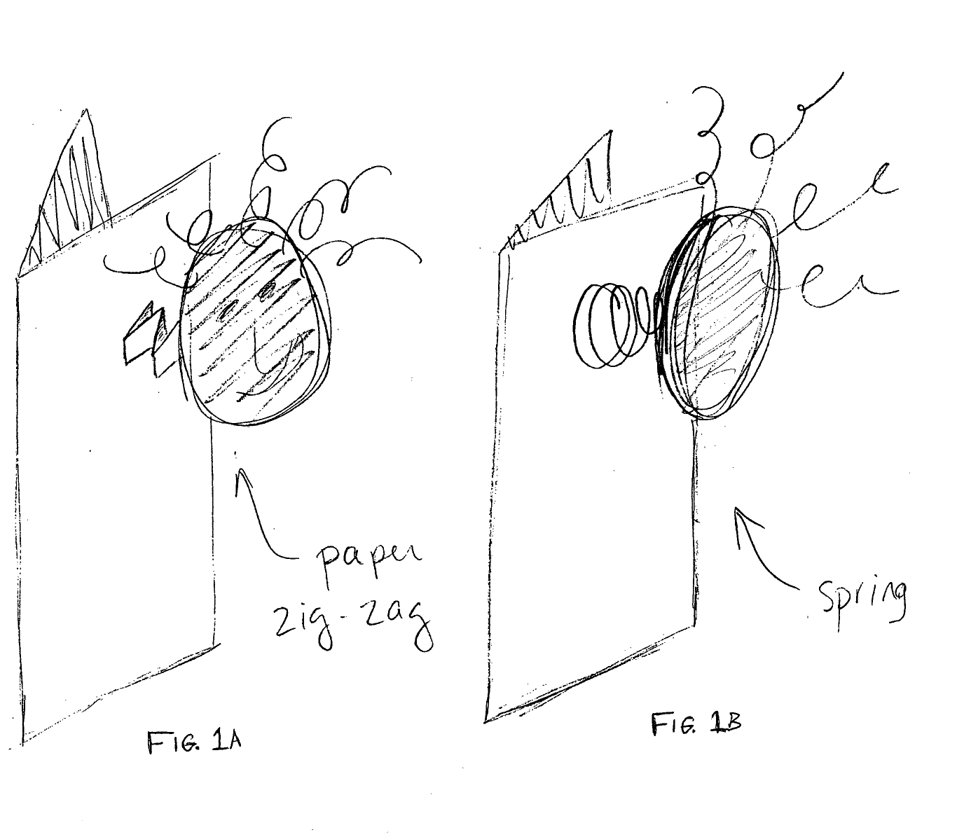

In one embodiment, using the full size counter card format (6¾″ by 4¾″, single side folded) a product according to the present invention includes an independent spring mounted die cut segment of the main image that is attached to the front panel so that when the consumer holds the card, part of the image has actual motion. In various embodiments, the spring mechanism is constructed of either accordion folded paper stock that is be tipped on (glued) to the front panel (see FIG. 1A) or coiled thin gauge wire (see FIG. 1B). Product presentation is completed by placing individual cards in clear plastic sleeves to protect the spring mechanism and card.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A motion card, comprising:
at least one panel displaying a main image;
at least one segment displaying at least one portion of said main image; and
a motion mechanism attached to said at least one panel, wherein said at least one segment is connected to said motion mechanism, and wherein said motion mechanism provides motion to said at least one portion of said main image.
